(19) United States
(12) Patent Application Publication
(10) Pub. No.: US 2024/0165475 A1
(43) Pub. Date: May 23, 2024

(54) BASEBALL BATTING PRACTICE BALL RETRIEVAL APPARATUS

(71) Applicant: TITAN MARKETING GROUP, INC., South Jordanj, UT (US)

(72) Inventors: Tony Chang, South Jordan, UT (US); Justin Jenkins, South Jordan, UT (US)

(73) Assignee: TITAN MARKETING GROUP, INC., South Jordan, UT (US)

(21) Appl. No.: 17/991,522

(22) Filed: Nov. 21, 2022

(51) Int. Cl. A63B 69/00

(52) U.S. Cl. CPC A63B 69/0002; A01K 87/00; A63B 2069/0008

(57) ABSTRACT

An apparatus and system are for providing ball batting practice and ball retrieval is provided. The apparatus includes a handle including a taper, a rod, and an offset body. The handle is connected to the offset body and the rod is connected to the offset body. The offset body separates the handle and the rod horizontally from each other. The system includes a bat, a ball, and a reel to interact with the apparatus to allow a ball to be hit and retrieved via the apparatus.

### TECHNICAL FIELD

The disclosure relates generally to an apparatus for retrieving a ball. The apparatus provides one or more tools which allow a ball connected to the apparatus to be pushed away from the apparatus and then retracted by the connection between the apparatus and the ball.

### BACKGROUND

Baseball is known as America's pastime and has been, on a historical basis, not only one of the most popular sports to play but also one of the most popular professional sports in terms of entertainment. Baseball requires one of the most difficult athletic movements in sport of any kind, batting. At professional levels, a batter has fractions of a second to decide whether or not to swing a bat at a ball. Accordingly, hand-eye coordination in professional baseball players is frequently the best of all professional athletes.

It goes without saying that batting a baseball is difficult. An old aphorism in baseball is that in baseball, failing 70% of the time will land a professional baseball player in the Hall of Fame. Indeed, a batter getting a hit on one out of three at bats (e.g., a 0.333 batting average) is extraordinary, but it also means that a professional baseball player does not get a hit in 2 of every 3 at bats.

There are a number of different characteristics which make hitting a baseball with a bat difficult. First, a speed of the ball gives limited time to swing a bat and contact the ball. Second, the ball may be high or low or inside (closer to the batter) or outside (farther from the batter), which means that any swing of the bat must not just be swung quickly, it must also be aimed accurately to contact the ball. Fast and accurate are typically adjectives that do not go well together. But the difficulty gets worse. Every baseball is made from natural materials which are not perfectly aerodynamic. Baseballs are made of leather which is stitched around a core to a standard. Even standard balls, however, can experience different aerodynamic conditions and reactions which can affect how a ball is hit by a bat. Massive curves in a pitch, heavy spin of the ball, light spin of the ball, no spin of the ball, and a host of other conditions can drastically affect how the ball is hit by a bat and how the ball reacts to being hit. Thus, excellent hitters must be fast, accurate, selective, and probably even a little lucky.

One of the most important factors in being an excellent baseball hitter is a hitter's mechanics, which is effectively the kinesiology of swinging a baseball bat. A batter's wrist position, elbow position, shoulder position, arm position, relative to each other and relative to a position of a batter's hip, legs, feet, and side all contribute to a batter's success in being able to swing quickly and accurately. Baseball hitters with the best mechanics typically develop the fastest and most accurate swings. Another one of the most important factors in being an excellent baseball hitter is having as many opportunities as possible to hit a baseball. In other words, experience hitting a baseball contributes to an ability to be selective about the pitches the batter wants to swing at. Experience is further helpful to practice excellent mechanics to train for speed and accuracy of a baseball swing.

Since hitting a baseball with a bat is so difficult, different implementations of bats and balls have been developed to give people, particularly children, a better chance to hit the ball and experience success with less skill. For example, The Wiffle Ball, Inc. of Shelton, Connecticut, produced a product called a Wiffle® ball. These balls are made in various configurations, e.g., baseball sized and larger, but are generally plastic balls with holes drilled throughout. These balls are made to be hit by plastic bats which may be regulation baseball sized balls or larger. In some cases, a ball and a bat may be oversized to reduce the accuracy necessary to swing a bat to hit a ball. A larger bat swinging at a larger ball is more likely to make contact with an oversized ball than a standard bat is likely to make contact with a standard sized ball. The increase in likelihood that a batter makes contact with a ball lessens the accuracy required to hit a ball which gives the batter an opportunity to practice increasing bat speed and reaction time without focusing as much on accuracy.

Another game, known as T-ball, was created to reduce the accuracy required to hit a ball and is a popular game for many young children. In T-ball, a baseball or other similarly sized ball, even a Wiffle® ball, is placed on a stand, known as a tee. The stand holds the ball in a fixed position which allows a batter to swing a bat at a ball that is not moving which removes any need for bat speed and reaction time and only requiring the most fundamental bat swing accuracy necessary to hit the ball (which can be lessened further by increasing the size of bat and ball, as discussed above). T-ball can be very enjoyable for young children because most can hit an oversized non-moving ball and some action occurs even when a child misses low and hits the tee because the ball resting on the tee is still propelled forward by the hit. In other words, a tee makes hitting a ball with a bat much simpler by removing the need for speed, accuracy, or selectivity. A tee, however, can be undesirable because the tee, as mentioned, can be hit by a bat, which fails to teach a batter any of the accuracy that is the principal benefit of playing T-ball.

Baseball, as a game, is based on movement of a ball around a baseball diamond. Basemen and fielders try to restrict the movement of a ball when it is hit and move that ball back to the batter's destination or the batter's person as quickly as possible. In a baseball game, there are nine players who cover the baseball diamond and play to prevent a baseball player from getting a hit (e.g., hitting the ball to a portion of the field where the fielders cannot catch it before it bounces or throw it to a base before the batter arrives at the base). These players' main purpose is to retrieve the ball and throw it to the base where the batter is running which is referred to as “fielding” the ball. One of the principal benefits of playing in an actual baseball game is that the opposing team is motivated to field the ball and throw the ball back after it is hit.

Outside of a game environment, batting practice can be a much bigger chore because there is no one to field the ball. In order to have continuous batting practice, a large number of baseballs are needed so that when a first ball is hit, another is ready to be hit before the first ball is fielded. By the end of batting practice, however, a batter may be responsible for collecting 50 or 100 baseballs for another round of batting practice. This is time consuming and takes away from the time the batter could be using to improve batting skills, such as speed, accuracy, and selectivity.

It is therefore, one object of this disclosure to provide an apparatus that provides an apparatus for retrieving a ball after each hit. It is another object of this disclosure to provide an apparatus that may also allow the batter to practice improving speed, accuracy, and selectivity in batting.

### SUMMARY

An apparatus is provided which includes a handle including a taper, a rod, and an offset body. The handle is connected to the offset body and the rod is connected to the offset body. The offset body separates the handle and the rod horizontally from each other.

A system is also provided which includes a bat, a ball, a reel, a handle, and a rod, and an offset body. The handle is connected to the offset body and the rod is connected to the offset body. The offset body separates the handle and the rod horizontally from each other.

### BRIEF DESCRIPTION OF THE DRAWINGS

Non-limiting and non-exhaustive implementations of the present disclosure are described with reference to the following figures, wherein like reference numerals refer to like parts throughout the various views unless otherwise specified. Advantages of the present disclosure will become better understood with regard to the following description and accompanying drawings:

FIG. 1 illustrates a ball batting and retrieval apparatus in a compact configuration.

FIG. 2 illustrates a ball batting and retrieval apparatus in an extended configuration.

FIG. 3 illustrates a ball batting and retrieval apparatus in a skeletonized embodiment.

FIG. 4 illustrates a ball batting and retrieval apparatus in use.

### DETAILED DESCRIPTION

In the following description, for purposes of explanation and not limitation, specific techniques and embodiments are set forth, such as particular techniques and configurations, in order to provide a thorough understanding of the device disclosed herein. While the techniques and embodiments will primarily be described in context with the accompanying drawings, those skilled in the art will further appreciate that the techniques and embodiments may also be practiced in other similar devices.

Reference will now be made in detail to the exemplary embodiments, examples of which are illustrated in the accompanying drawings. Wherever possible, the same reference numbers are used throughout the drawings to refer to the same or like parts. It is further noted that elements disclosed with respect to particular embodiments are not restricted to only those embodiments in which they are described. For example, an element described in reference to one embodiment or figure, may be alternatively included in another embodiment or figure regardless of whether or not those elements are shown or described in another embodiment or figure. In other words, elements in the figures may be interchangeable between various embodiments disclosed herein, whether shown or not.

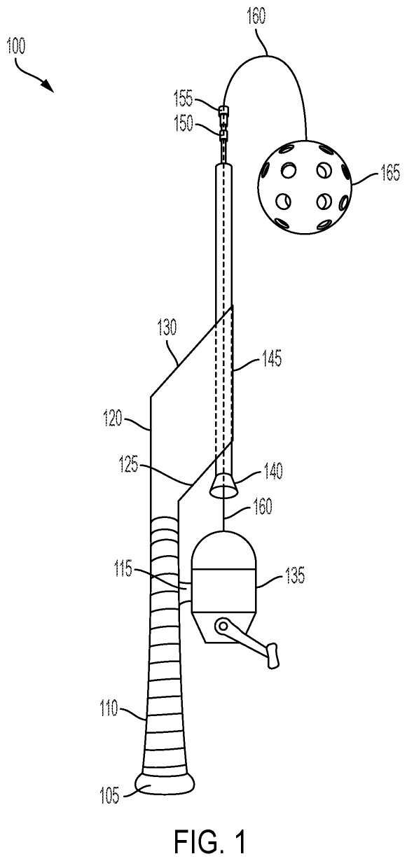

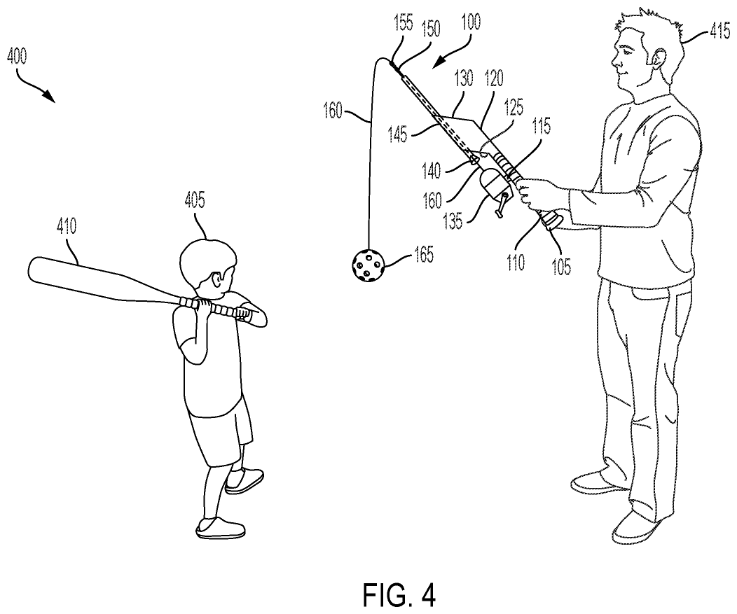

FIG. 1 illustrates a ball batting and retrieval apparatus 100 in a compact configuration. Ball batting and retrieval apparatus 100 may include a knob 105 and a handle 110 which are configured in a baseball bat style. That is to say that knob 105 may generally have a diameter that is larger than the handle section of ball batting and retrieval apparatus 100 while handle 110 includes a grip, such as grip tape, and which tapers from a knob 105 on a first end towards what would be a barrel of a conventional baseball bat. However, handle 110 may be fitted with a reel seat 115, which is known to anglers in the use of fishing rods, to attach a fishing reel to a fishing rod. A reel seat 115 typically includes an upper foot and a lower foot where one of the upper foot and the lower fit is fixed in a particular position and the other of the upper or lower foot is adjustable closer or farther from the upper foot or lower foot to capture or release a reel foot of a fishing reel, such as fishing reel 135, which will be discussed below. Handle 110 may taper from a largest portion at the knob 105 on the first end towards body offset 120, as will be discussed below. Installing handle 110 in this fashion functions as an instructional device so that the user of ball batting and retrieval apparatus 100 can demonstrate correct bat holding skills, hand positioning, and use while another user mimics the action with a bat, as will be discussed with respect to FIG. 4. Handle 110 may be a bat handle, with the only difference being the incorporation of reel seat 115 to ensure that handle 110 mimics a bat handle as much as possible. It is also noted that the grip, grip tape, or any grip enhancement may or may not be continuous from knob 110 to body offset 120, which is to say, that reel seat 115 may also include some portion of grip material in the handle to mimic a bat as much as possible.

Handle 110 may be connected to a body offset 120, which is bounded by a lower connector 125 on a bottom of body offset 120 and by an upper connector 130 on a top of body offset 120 included in ball batting and retrieval apparatus 100. Body offset 120 is shown as being a single piece structure which extends from handle 110 as a single piece. Body offset 120 being constructed as a single piece adds strength and rigidity to ensure that an errant bat swing does not break body offset 120. Body offset 120 may be a single piece with handle 110 or may be a single piece that connects to handle 110. Body offset 120 may also attach to a telescoping rod 145 in a manner that allows focusing cone 140 to be situated directly over reel 135. Body offset 120 holds telescoping rod 145 directly over reel 135 to reduce friction in allowing line to travel into focusing cone 140 and through a hollow portion of telescoping rod 145. Since line, such as fishing line, travels off the reel in non-straight lines (e.g., fishing line oscillates as it flies off a fishing reel), focusing cone 140 focuses these oscillations into smaller oscillations and, ideally, into as straight of a line as possible as the line travels through telescoping rod 145 to reduce friction between telescoping rod 145 and line 160. Said another way, handle 110 of ball batting and retrieval apparatus 100 may be offset from telescopic rod 145 such that they are disposed in parallel but different axes. In other words, an axis defined by and traveling vertically through a length of handle 110 may be parallel to an axis defined by and traveling vertically through a length of telescoping rod 145 where the axis defined by a length of handle 110 and an axis traveling through a length of telescoping rod 145 are different axes offset from each other by a distance.

Telescoping rod 145 may be included in ball batting and retrieval apparatus 100 and may be constructed from types of plastic, fiberglass, graphite, composites, or any other material known to those of ordinary skill in the art while knob, handle, and body offset 120 may be constructed generally of plastic materials. Telescoping rod 145 may include one or a plurality of sections which may connect to each other using a male/female interference fit or may be successively disposed within each other in a telescoping fashion. As shown in FIG. 1, telescoping rod 145, first section, 150, and second section 155 are collapsed in a compact configuration because telescoping rod 145, first section 150, and second section 155 are substantially nested within each other. Telescoping rod 145 is shown as a telescoping rod but may “telescope” by adding other sections in a male/female interference fit instead of being successively disposed within each other. As shown telescoping rod 145 includes a first section 150 and a second section 155 which respectively have decreasing internal and outside diameters.

For example, a bottom of first section 150 may have a larger diameter than a top end of telescoping rod 145 such that when first section 150 is pulled through telescoping rod 145, an outside of first section 150 contacts an inside section of telescoping rod 145 and is held in place by friction between the outside of first section 150 and the inside section of telescoping rod 145. Similarly, a bottom of second section 155 may have a larger diameter than a top of first section 150 such that when second section 155 is pulled through telescoping rod 145 and first section 150, an outside of second section 155 contacts an inside section of first section 155 and is held in place by friction between the outside of second section 155 and an inside of first section 150. Telescoping rod 145 is shown as having two telescoping sections but is not so limited. More or fewer sections may be provided and operate as discussed above.

As previously mentioned, telescoping rod 145, first section 150, and second section 155 may be hollow. In other words, telescoping rod 145, first section 150, and second section 155 may be constructed by wrapping material around a mandrel which leaves a hollow core down the center of telescoping rod 145, first section 150, and second section 155. Line may travel from reel 135 through focusing cone 140 and into rod 145, first section 150, and second section 155 and extend from second section 155 (which may or may not be the last section depending on how many sections are provided). However, in the embodiment shown in FIG. 1, line 160 exits telescoping rod 145, first section 150, and second section 155 at a top of second section 155 and may connect to a ball 165. Line 160 may be any cordage appropriate for the application. In one embodiment, line 160 may be monofilament, fluorocarbon, or braided fishing line. In another embodiment, line 160 may include a plastic connector for connecting to ball 165. Line 160 may be twine, string, or any other type of cordage which may be collected and dispensed by reel 135.

Reel 135 may be included in ball batting and retrieval apparatus 100 and may be a conventionally used fishing reel. As shown in FIG. 1, reel 135 is a reel known as a closed face reel but may be implemented as a spinning or conventional reel, as desired. All modern fishing reels, whether closed face, open face (or spinning), or conventional, include three main parts, a line release, a handle, and a spool. The line release selectively allows line to be dispensed from the spool where line is stored. The handle may be used to rotate the spool to collect line back onto the spool. Reel 135 may include these components to dispense line 160 from a spool contained within reel 135 and to collect line 160 back onto the spool within reel 135.

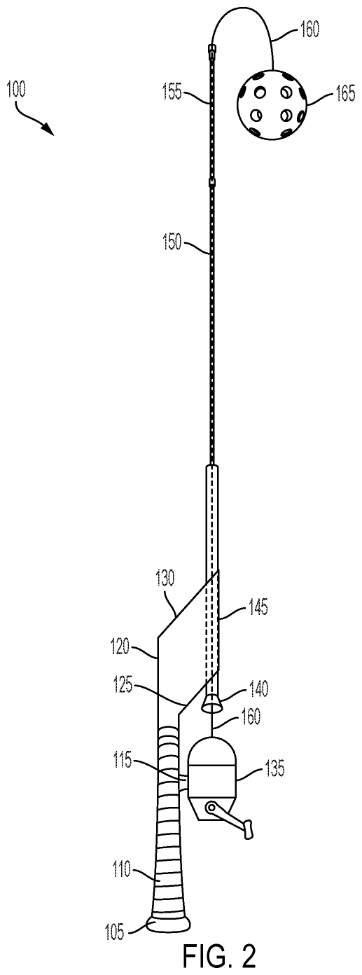

FIG. 2 illustrates a ball batting and retrieval apparatus 100 in an extended configuration. Ball batting and retrieval apparatus 100 may include a knob 105 and a handle 110 which are configured in a baseball bat style. That is to say that knob 105 may generally have a diameter that is larger than the handle section of ball batting and retrieval apparatus 100 while handle 110 includes a grip and which tapers towards a barrel of a conventional baseball bat. However, handle 110 may be fitted with a reel seat 115, which is known to anglers in the use of fishing rods, to attach a fishing reel to a fishing rod. A reel seat 115 typically includes an upper foot and a lower foot where one of the upper foot and the lower fit is fixed in a particular position and the other of the upper or lower foot is adjustable closer or farther from the upper foot or lower foot to capture or release a reel foot of a fishing reel, such as fishing reel 135, which will be discussed below.

Handle 110 may be connected to a body offset 120, which is bounded by a lower connector 125 on a bottom of body offset 120 and by an upper connector 130 on a top of body offset 120 included in ball batting and retrieval apparatus 100. Body offset 120 is shown as being a single piece structure which extends from handle 110 which attaches to a telescoping rod 145 in a manner that allows focusing cone 140 to be situated directly over reel 135. Body offset 120 holds telescoping rod 145 directly over reel 135 to reduce friction in allowing line to travel into focusing cone 140 and through a hollow portion of telescoping rod 145. Since line, such as fishing line, travels off the reel in non-straight lines (e.g., fishing line oscillates as it flies off a fishing reel), focusing cone 140 focuses these oscillations into smaller oscillations and, ideally, into as straight of a line as possible as the line travels through telescoping rod 145 to reduce friction between telescoping rod 145 and line 160.

Telescoping rod 145 may be included in ball batting and retrieval apparatus 100 and may be constructed from types of plastic, fiberglass, graphite, composites, or any other material known to those of ordinary skill in the art while knob, handle, and body offset 120 may be constructed generally of plastic materials. Telescoping rod 145 may include one or a plurality of sections which may connect to each other using a male/female interference fit or may be successively disposed within each other in a telescoping fashion. As shown in FIG. 2, telescoping rod 145, first section, 150, and second section 155 are extended in an extended configuration because telescoping rod 145, first section 150, and second section 155 are extended to maximum length. Telescoping rod 145 is shown as a telescoping rod but may “telescope” by adding other sections in a male/female interference fit instead of being successively disposed within each other. As shown telescoping rod 145 includes a first section 150 and a second section 155 which respectively have decreasing internal and outside diameters.

For example, a bottom of first section 150 may have a larger diameter than a top end of telescoping rod 145 such that when first section 150 is pulled through telescoping rod 145, an outside of first section 150 contacts an inside section of telescoping rod 145 and is held in place by friction between the outside of first section 150 and the inside section of telescoping rod 145. Similarly, a bottom of second section 155 may have a larger diameter than a top of first section 150 such that when second section 155 is pulled through telescoping rod 145 and first section 150, an outside of second section 155 contacts an inside section of first section 155 and is held in place by friction between the outside of second section 155 and an inside of first section 150. FIG. 2 illustrates telescoping rod 145, first section 150, and second section 155 as fully extended, and each respective piece in an interference fit with another piece to reach full extension of ball batting retrieval apparatus 100. Ball batting retrieval apparatus 100 is shown in an extended configuration which is intended for actual use of ball batting retrieval apparatus 100. Telescoping rod 145 is shown as having two telescoping sections but is not so limited. More or fewer sections may be provided and operate as discussed above.

As previously mentioned, telescoping rod 145, first section 150, and second section 155 may be hollow. In other words, telescoping rod 145, first section 150, and second section 155 may be constructed by wrapping material around a mandrel which leaves a hollow core down the center of telescoping rod 145, first section 150, and second section 155. Line may travel from reel 135 through focusing cone 140 and into rod 145, first section 150, and second section 155 and extend from second section 155 (which may or may not be the last section depending on how many sections are provided). However, in the embodiment shown in FIG. 2, line 160 exits telescoping rod 145, first section 150, and second section 155 at a top of second section 155 and may connect to a ball 165. Line 160 may be any cordage appropriate for the application. In one embodiment, line 160 may be monofilament, fluorocarbon, or braided fishing line. In another embodiment, line 160 may include a plastic connector for connecting to ball 165. Line 160 may be twine, string, or any other type of cordage which may be collected and dispensed by reel 135.

Reel 135 may be included in ball batting and retrieval apparatus 100 and may be a conventionally used fishing reel. As shown in FIG. 2, reel 135 is a reel known as a closed face reel but may be implemented as a spinning or conventional reel, as desired. All modern fishing reels, whether closed face, open face (or spinning), or conventional, include three main parts, a line release, a handle, and a spool. The line release selectively allows line to be dispensed from the spool where line is stored. The handle may be used to rotate the spool to collect line back onto the spool. Reel 135 may include these components to dispense line 160 from a spool contained within reel 135 and to collect line 160 back onto the spool within reel 135.

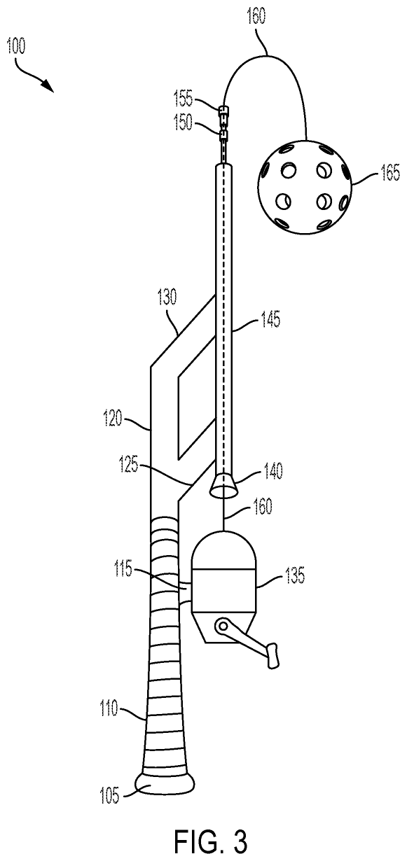

FIG. 3 illustrates a ball batting and retrieval apparatus 100 in a skeletonized embodiment. Ball batting and retrieval apparatus 100 may include a knob 105 and a handle 110 which are configured in a baseball bat style. That is to say that knob 105 may generally have a diameter that is larger than the handle section of ball batting and retrieval apparatus 100 while handle 110 includes a grip and which tapers towards a barrel of a conventional baseball bat. However, handle 110 may be fitted with a reel seat 115, which is known to anglers in the use of fishing rods, to attach a fishing reel to a fishing rod. A reel seat 115 typically includes an upper foot and a lower foot where one of the upper foot and the lower fit is fixed in a particular position and the other of the upper or lower foot is adjustable closer or farther from the upper foot or lower foot to capture or release a reel foot of a fishing reel, such as fishing reel 135, which will be discussed below.

Handle 110 may be connected to a body offset 120, which is bounded by a lower connector 125 on a bottom of body offset 120 and by an upper connector 130 on a top of body offset 120 included in ball batting and retrieval apparatus 100. Body offset 120 is shown as being a single piece structure which extends from handle 110 which attaches to a telescoping rod 145 in a manner that allows focusing cone 140 to be situated directly over reel 135. As shown in FIG. 3, body offset 120 is implemented in a skeletonized configuration by having upper connector 130 and lower connector 125 connecting directly to rod 145 at different points on body offset 120. For example, body offset 120 may be considered to have a “hole” disposed between lower connector 125, upper connector 130, body offset 120 and telescoping rod 145. In this manner, lower connector 125 and upper connector 130 may act as first and second arms which extend from body offset 120 to telescoping rod 140. Lower connector 125 and upper connector 130 may each be implemented as single arms or as double arms attaching to opposing sides of rod 145, for example. This embodiment may reduce weight from ball batting and retrieval apparatus 100 while also providing offset for telescoping rod 145 and focusing cone 140 to be disposed directly over reel 135.

Body offset 120 holds telescoping rod 145 directly over reel 135 to reduce friction in allowing line to travel into focusing cone 140 and through a hollow portion of telescoping rod 145. Since line, such as fishing line, travels off the reel in non-straight lines (e.g., fishing line oscillates as it flies off a fishing reel), focusing cone 140 focuses these oscillations into smaller oscillations and, ideally, into as straight of a line as possible as line 160 travels through telescoping rod 145 to reduce friction between telescoping rod 145 and line 160.

Telescoping rod 145 may be included in ball batting and retrieval apparatus 100 and may be constructed from types of plastic, fiberglass, graphite, composites, or any other material known to those of ordinary skill in the art while knob, handle, and body offset 120 may be constructed generally of plastic materials. Telescoping rod 145 may include one or a plurality of sections which may connect to each other using a male/female interference fit or may be successively disposed within each other in a telescoping fashion. As shown in FIG. 3, telescoping rod 145, first section, 150, and second section 155 are collapsed in a compact configuration because telescoping rod 145, first section 150, and second section 155 are substantially nested within each other. Telescoping rod 145 is shown as a telescoping rod but may “telescope” by adding other sections in a male/female interference fit instead of being successively disposed within each other. As shown telescoping rod 145 includes a first section 150 and a second section 155 which respectively have decreasing internal and outside diameters.

For example, a bottom of first section 150 may have a larger diameter than a top end of telescoping rod 145 such that when first section 150 is pulled through telescoping rod 145, an outside of first section 150 contacts an inside section of telescoping rod 145 and is held in place by friction between the outside of first section 150 and the inside section of telescoping rod 145. Similarly, a bottom of second section 155 may have a larger diameter than a top of first section 150 such that when second section 155 is pulled through telescoping rod 145 and first section 150, an outside of second section 155 contacts an inside section of first section 155 and is held in place by friction between the outside of second section 155 and an inside of first section 150. Telescoping rod 145 is shown as having two telescoping sections but is not so limited. More or fewer sections may be provided and operate as discussed above.

As previously mentioned, telescoping rod 145, first section 150, and second section 155 may be hollow. In other words, telescoping rod 145, first section 150, and second section 155 may be constructed by wrapping material around a mandrel which leaves a hollow core down the center of telescoping rod 145, first section 150, and second section 155. Line may travel from reel 135 through focusing cone 140 and into rod 145, first section 150, and second section 155 and extend from second section 155 (which may or may not be the last section depending on how many sections are provided). However, in the embodiment shown in FIG. 3, line 160 exits telescoping rod 145, first section 150, and second section 155 at a top of second section 155 and may connect to a ball 165. Line 160 may be any cordage appropriate for the application. In one embodiment, line 160 may be monofilament, fluorocarbon, or braided fishing line. In another embodiment, line 160 may include a plastic connector for connecting to ball 165. Line 160 may be twine, string, or any other type of cordage which may be collected and dispensed by reel 135.

Reel 135 may be included in ball batting and retrieval apparatus 100 and may be a conventionally used fishing reel. As shown in FIG. 3, reel 135 is a reel known as a closed face reel but may be implemented as a spinning or conventional reel, as desired. All modern fishing reels, whether closed face, open face (or spinning), or conventional, include three main parts, a line release, a handle, and a spool. The line release selectively allows line to be dispensed from the spool where line is stored. The handle may be used to rotate the spool to collect line back onto the spool. Reel 135 may include these components to dispense line 160 from a spool contained within reel 135 and to collect line 160 back onto the spool within reel 135.

FIG. 4 illustrates a ball batting and retrieval apparatus 100 in use with system 400, which could be implemented also as a kit. Ball batting and retrieval apparatus 100 may include a knob 105 and a handle 110 which are configured in a baseball bat style. That is to say that knob 105 may generally have a diameter that is larger than the handle section of ball batting and retrieval apparatus 100 while handle 110 includes a grip and which tapers towards a barrel of a conventional baseball bat. However, handle 110 may be fitted with a reel seat 115, which is known to anglers in the use of fishing rods, to attach a fishing reel to a fishing rod. A reel seat 115 typically includes an upper foot and a lower foot where one of the upper foot and the lower fit is fixed in a particular position and the other of the upper or lower foot is adjustable closer or farther from the upper foot or lower foot to capture or release a reel foot of a fishing reel, such as fishing reel 135, which will be discussed below.

Handle 110 may be connected to a body offset 120, which is bounded by a lower connector 125 on a bottom of body offset 120 and by an upper connector 130 on a top of body offset 120 included in ball batting and retrieval apparatus 100. Body offset 120 is shown as being a single piece structure which extends from handle 110 which attaches to a telescoping rod 145 in a manner that allows focusing cone 140 to be situated directly over reel 135. Body offset 120 holds telescoping rod 145 directly over reel 135 to reduce friction in allowing line to travel into focusing cone 140 and through a hollow portion of telescoping rod 145. Since line, such as fishing line, travels off the reel in non-straight lines (e.g., fishing line oscillates as it flies off a fishing reel), focusing cone 140 focuses these oscillations into smaller oscillations and, ideally, into as straight of a line as possible as the line travels through telescoping rod 145 to reduce friction between telescoping rod 145 and line 160.

Telescoping rod 145 may be included in ball batting and retrieval apparatus 100 and may be constructed from types of plastic, fiberglass, graphite, composites, or any other material known to those of ordinary skill in the art while knob, handle, and body offset 120 may be constructed generally of plastic materials. Telescoping rod 145 may include one or a plurality of sections which may connect to each other using a male/female interference fit or may be successively disposed within each other in a telescoping fashion. As shown in FIG. 4, telescoping rod 145, first section, 150, and second section 155 are collapsed in a compact configuration because telescoping rod 145, first section 150, and second section 155 are substantially nested within each other. Telescoping rod 145 is shown as a telescoping rod but may “telescope” by adding other sections in a male/female interference fit instead of being successively disposed within each other. As shown telescoping rod 145 includes a first section 150 and a second section 155 which respectively have decreasing internal and outside diameters.

For example, a bottom of first section 150 may have a larger diameter than a top end of telescoping rod 145 such that when first section 150 is pulled through telescoping rod 145, an outside of first section 150 contacts an inside section of telescoping rod 145 and is held in place by friction between the outside of first section 150 and the inside section of telescoping rod 145. Similarly, a bottom of second section 155 may have a larger diameter than a top of first section 150 such that when second section 155 is pulled through telescoping rod 145 and first section 150, an outside of second section 155 contacts an inside section of first section 155 and is held in place by friction between the outside of second section 155 and an inside of first section 150. Telescoping rod 145 is shown as having two telescoping sections but is not so limited. More or fewer sections may be provided and operate as discussed above.

As previously mentioned, telescoping rod 145, first section 150, and second section 155 may be hollow. In other words, telescoping rod 145, first section 150, and second section 155 may be constructed by wrapping material around a mandrel which leaves a hollow core down the center of telescoping rod 145, first section 150, and second section 155. Line may travel from reel 135 through focusing cone 140 and into rod 145, first section 150, and second section 155 and extend from second section 155 (which may or may not be the last section depending on how many sections are provided). However, in the embodiment shown in FIG. 4, line 160 exits telescoping rod 145, first section 150, and second section 155 at a top of second section 155 and may connect to a ball 165. Line 160 may be any cordage appropriate for the application. In one embodiment, line 160 may be monofilament, fluorocarbon, or braided fishing line. In another embodiment, line 160 may include a plastic connector for connecting to ball 165. Line 160 may be twine, string, or any other type of cordage which may be collected and dispensed by reel 135.

Reel 135 may be included in ball batting and retrieval apparatus 100 and may be a conventionally used fishing reel. As shown in FIG. 4, reel 135 is a reel known as a closed face reel but may be implemented as a spinning or conventional reel, as desired. All modern fishing reels, whether closed face, open face (or spinning), or conventional, include three main parts, a line release, a handle, and a spool. The line release selectively allows line to be dispensed from the spool where line is stored. The handle may be used to rotate the spool to collect line back onto the spool. Reel 135 may include these components to dispense line 160 from a spool contained within reel 135 and to collect line 160 back onto the spool within reel 135.

As shown in FIG. 4, an operator 415 of ball batting and retrieval apparatus 100 has extended line 160 by dispensing line from reel 135 through focusing cone 140, telescoping rod 145, first section 150, and second section 155 to present ball 165 to an operator 405 of bat 410. Bat 410 may be a plastic or wooden bat which is suitable for a plastic or other ball made of natural and/or synthetic materials. Operator 415 may operate reel 135 to allow for an operator 405 to swing bat 410 at ball 165. In one embodiment, operator 415 may interface with reel 135 to disengage the spool within reel 135 to dispense line. At the same time, operator 405 of bat 410 may swing the bat and contact ball 165. As ball 165 is hit and travels away from bat 410, ball 165 slows down and comes to a stop. Operator 414 may then engage the spool within reel 135 by cranking the handle of reel 135 to draw line 160 back on to the spool. Since line 160 is connected to ball 165, operator 415 may quickly reel ball 165 back into position for operator 405 of bat 410 to hit again.

In one embodiment, operator 415 may cause ball 165 to hang freely in substantially the same place giving operator 405 an opportunity to practice bat swinging mechanics without testing speed, accuracy, or selectivity. In another embodiment, operator 415 may move ball batting and retrieval apparatus 100 to cause ball 165 to move unpredictably for operator 405 of bat 410. This may cause operator 405 of bat 410 to practice swinging bat 410 at a correct speed, with a degree of accuracy, and selectively (e.g., when a ball is at a top or bottom of a vertical bounce or on the inside most or outside most point of a circle, etc.). In other words, the timing associated with excellent hitting may be learned by use of ball batting and retrieval apparatus 100 in a way that simulates batting a ball thrown by a pitcher in an actual baseball game.

The foregoing description has been presented for purposes of illustration. It is not exhaustive and does not limit the invention to the precise forms or embodiments disclosed. Modifications and adaptations will be apparent to those skilled in the art from consideration of the specification and practice of the disclosed embodiments. For example, components described herein may be removed and other components added without departing from the scope or spirit of the embodiments disclosed herein or the appended claims.

Other embodiments will be apparent to those skilled in the art from consideration of the specification and practice of the disclosure disclosed herein. It is intended that the specification and examples be considered as exemplary only, with a true scope and spirit of the invention being indicated by the following claims.

What is claimed is:

1. An apparatus, comprising:
a handle including a taper,
a rod; and
an offset body, wherein the handle is connected to the offset body and the rod is connected to the offset body, the offset body separating the handle and the rod horizontally from each other.

2. The apparatus of claim 1, wherein the taper on the handle tapers from a knob on the handle at a widest end towards the offset body to form a bat handle.

3. The apparatus of claim 1, further comprising a reel seat disposed on the handle.

4. The apparatus of claim 3, further comprising a reel connectable to the reel seat on the handle.

5. The apparatus of claim 1, wherein the offset body includes an upper connector and a lower connector to connect the offset body to the rod.

6. The apparatus of claim 5, wherein the upper connector and the lower connector comprise arms.

7. The apparatus of claim 6, wherein the upper connector comprises one or more arms.

8. The apparatus of claim 6, wherein the lower connector comprises one or more arms.

9. The apparatus of claim 1, wherein the rod is hollow.

10. The apparatus of claim 1, wherein the rod comprises multiple rod sections.

11. The apparatus of claim 1, wherein the multiple rod sections connect by a male/female interference connection.

12. The apparatus of claim 10, wherein the multiple rod sections are telescoping.

13. The apparatus of claim 1, further comprising a focusing cone disposed on the rod.

14. The apparatus of claim 1, wherein the focusing cone is disposed on a bottom of the rod.

15. The apparatus of claim 1, wherein the focusing cone is positioned to receive line into the focusing cone from a reel connected to the handle.

16. The apparatus of claim 15, wherein a distance that separates the rod from the handle positions the focusing cone directly above the reel when the reel is connected to the handle.

17. The apparatus of claim 1, wherein an axis defining a length of the handle is different from and parallel to an axis defining a length of the rod.

18. A system, comprising:
a bat;
a ball;
a reel;
a handle;
a rod; and
an offset body, wherein the handle is connected to the offset body and the rod is connected to the offset body, the offset body separating the handle and the rod horizontally from each other.

19. The system of claim 18, wherein line disposed in the reel is connectable through the rod to the ball.

20. The system of claim 18, wherein an axis defining a length of the handle is different from and parallel to an axis defining a length of the rod.
